(19) United States
(12) Patent Application Publication
(10) Pub. No.: US 2006/0279081 A1
(43) Pub. Date: Dec. 14, 2006

(54) Universal connector

(76) Inventor: Ben-Why Liao, Wu-Feng Hsian (TW)

Correspondence Address: G. LINK Co., LTD., 3550 Bell Road, MINOOKA, IL, 60447, US

(21) Appl. No.: 11/149,376

(22) Filed: Jun. 10, 2005

(51) Int. Cl. F16L 39/00

(52) U.S. Cl. 285/124.2

(57) ABSTRACT

A universal connector has a screw thread section and a cone section. The screw thread section connects with an output pipe or a recycling pipe of a cleaning device of an air conditioning system in a car. The cone section provides a plurality of flanges at the outer sides thereof and connects with a connection member of the air conditioning system. The screw thread section connects with a C shaped strap plate, which has a C shaped groove, is passed through a screw and the C shaped strap plate perpendicularly engaging with the screw by way of two nuts such that the connector is co-axial with a fitting hole in the connection member and move rectilinearly along a direction in parallel with the screw, which is fixed to the connection member.

### BACKGROUND OF THE INVENTION

1. Field of the Invention

The present invention is related to improvement of a universal connector disclosed in Taiwanese Patent Application No. 93208090 and particularly to a connector of a cleaner especially for an air conditioning circulation system in a car.

2. Brief Description of the Related Art

Taiwanese Patent Application No. 93208090 discloses a conical connector between the cleaner and the air conditioning circulation system. The conical connector is joined to a connecting hole of a connection member in the air conditioning circulation system. The conical connector is capable of adapting to the connecting hole in different sizes such that it is not necessary to prepare the connector in different sizes adapting to the connecting hole in different sizes. Hence, it is required for the connector providing so many sizes. In addition, a secure sleeve is provided for the conical connector to be joined to the connection member. Although the prior art is much better than the traditional connector in use, there are still a number of deficiencies in the prior art and it is a subject worth us to make improvement.

### SUMMARY OF THE INVENTION

In order to overcome the deficiencies resided in the prior art, the universal connector of the present invention has made full improvement on the connector so as to be capable of adapting to the connection member of the air conditioning circulation systems in all brands of cars without causing assembling problems resulting from space limitation, improper locations and unsuitable sizes.

An object of the present invention is to provide a universal connector with which the air conditioning circulation systems of all brands of cars can be connected to a cleaner easily and fast.

Another object of the present invention is to provide a universal connector in which an upper connection part and a lower connection part are provided to reduce the size and the weight of the entire connector.

A further object of the present invention is to provide a universal connector with which the connection between the cleaner and the air conditioning circulation is much easier without any restrictions caused by space limitation and obstacles resulting from part location.

A further object of the present invention is to provide a universal connector, which is adaptable to the connection member in different sizes of fitting holes so as to reduce production cost due to less material and weight substantively.

### BRIEF DESCRIPTION OF THE DRAWINGS

The detail structure, the applied principle, the function and the effectiveness of the present invention can be more fully understood with reference to the following description and accompanying drawings, in which:

FIG. 1A is a front view of the first embodiment of a universal connector according to the present invention;

FIG. 1B is a top view of the first embodiment of a universal connector according to the present invention;

FIG. 1C is a sectional view illustrating an anti-leak member being added to the universal connector of the present invention;

FIG. 2A is a front view of the second embodiment of a connection device in a universal connector according to the present invention;

FIG. 2B is a top view of the first embodiment of a universal connector according to the present invention;

FIG. 3 is a front view of the second embodiment of a universal connector according to the present invention;

FIG. 4A is a plan view of a union used in the universal connector according to the present invention;

FIG. 4B is a plan view of another union used in the connection device in a universal connector according to the present invention;

FIG. 5 is a plan view illustrating assembly of the fourth embodiment of a connection device in a universal connector according present invention; and

FIG. 6 is a sectional view illustrating another embodiment of anti-leak member.

### DETAILED DESCRIPTION OF THE PREFERRED EMBODIMENTS

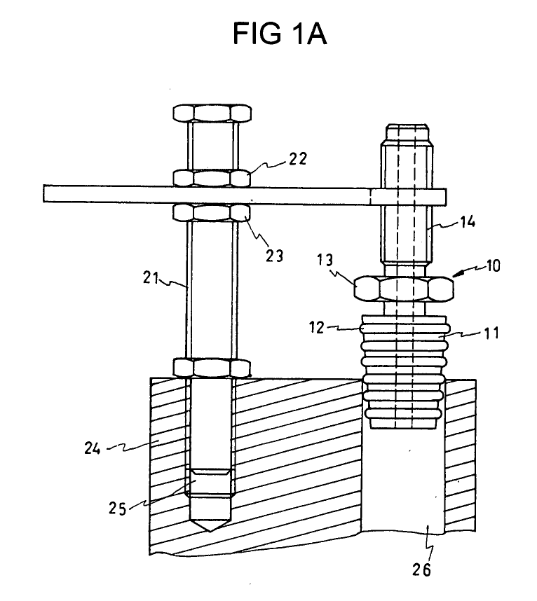

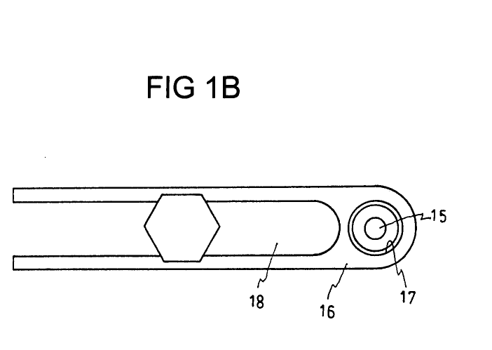

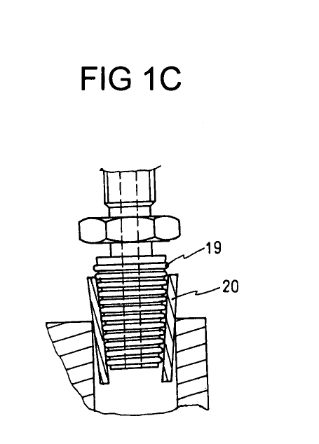

Referring to FIGS. 1A, 1B and 1C, the first preferred embodiment of a universal connector according to the present invention is illustrated. A connector 10 is inserted into the fitting hole 26 of a connection member 24 after a screw thread hole 25 in the connection member 24 is fastened a bolt 21 with two nuts 22, 23. An elongated C shaped strap plate 16 has a screw thread hole 17 engages with a screw thread section 14 on the connector 10 and an elongated C shaped hollow part 18 thereof is passed through with the bolt 21 such that the C shaped strap plate 16 can be adjusted the elevation thereof before being secured. In this way, a cone part 11 of the connector 10 is just disposed above the fitting hole 26 such that the connector 10 is co-axial with the fitting hole 26 and parallel to the bolt 21. Once a nut shaped part 13 is rotated, the connector 10 can move upward or downward due to the screw thread section 14 engaging with the screw thread hole 17 and it results in tightness between the conical part 11 and the fitting hole 26 can be regulated to obtain effect of anti-leakage via sealing rings 12.

Further, a plurality of flanges 19 can be provided on the conical part 11 and a sealing cone member 20 fits with the flanges 19 such that the sealing cone member 20 performs tight fit with the fitting hole 26 to obtain function of anti-leakage.

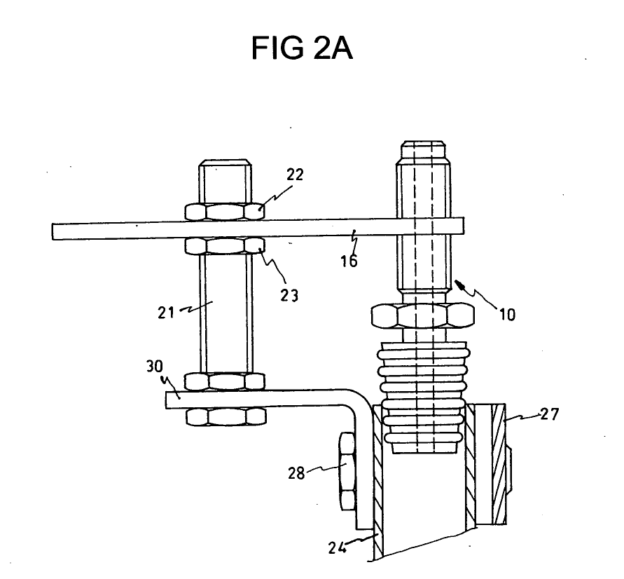

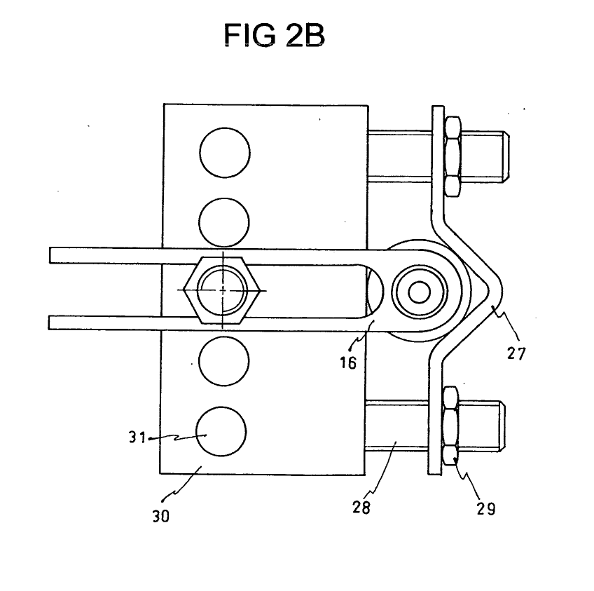

Referring to FIGS. 2A and 2B, another embodiment of the present invention is illustrated. When the connection part 24 is used in the air conditioning circulation system and no screw threads thereon for engaging with the bolt 21, a holding seat 27 and a locating plate 30 are attached to the connection part 24 with a bolt 28 and a nut in case of the connection part 24 being capable of being held. The locating plate 30 or the holding seat 27 can provide a hollow part 18 for being passed by the bolt 28 to facilitate assembling job without being restricted by space limitation. The locating plate 30 has a plurality of through holes for being passed by the bolt 21 and connector 10 connects with a C shaped strap plate 16. The C shaped strap plate 16 is fastened with the two nuts 22, 23 after the connector 10 being inserted by the bolt 21. Once the connector 10 rotates, the connection part 24 can obtain tight fit with the connection part 24.

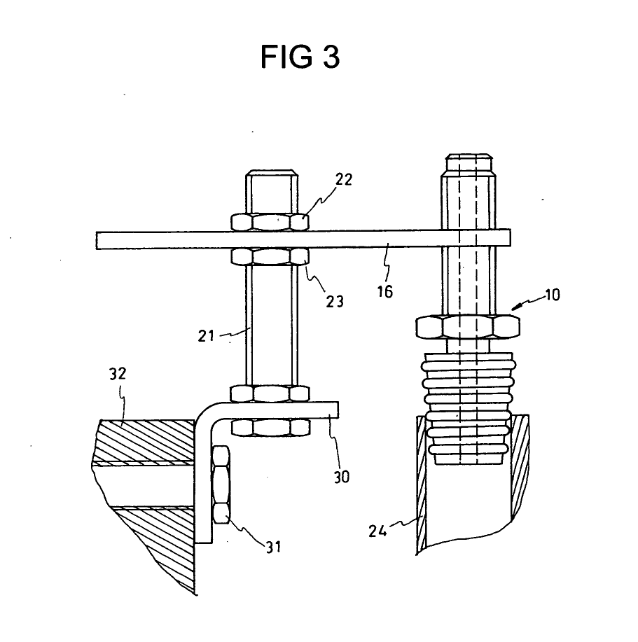

Referring to FIG. 3, the third embodiment of the present invention is illustrated. In case of the connection part 24 being incapable of offering screw threads for engaging with the connector 10 or no holding component being available, any locators 32 disposed around the air conditioning circulation system is applied to be attached with the locating plate 30 with a screw 31. In this way, the screw 21 can be fixed to the locating plate 30. Further, the elongated C shaped strap plate 16 is fixedly attached to the connector 10 as it is done in the preceding two embodiments so that the connector 10 can be adapted to the air conditioning circulation system while the system is cleaned.

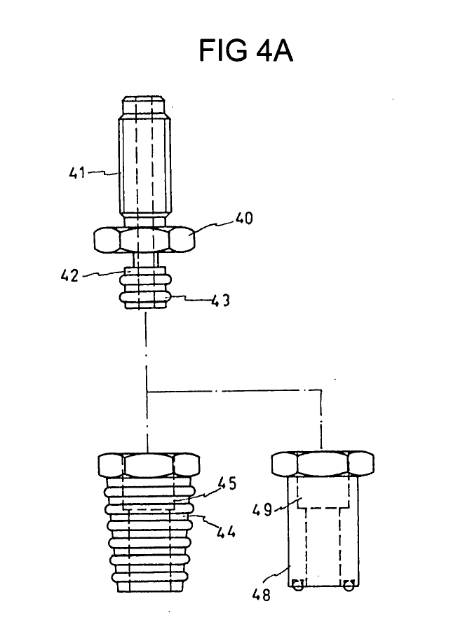

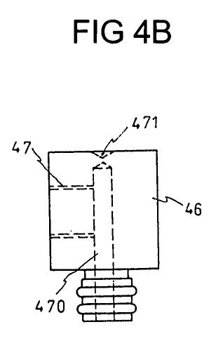

Referring to FIGS. 4A and 4B, due to space around the air conditioning circulation system in a car being limited, it is helpful if the connector can be made as smaller as possible. In order to meet the requirement, the connector is designed to have an upper connection part 40 and a lower connector part 44. The upper connector part 40 has a screw thread section 41 extending to an end thereof with another end thereof being a stem 42 and the stem 42 is attached with sealing rings 43. The lower connector part 44 has joining hole 45 for being inserted with the stem 42 such that the upper and lower connector part 40 can be assembled to the lower connector part 44 as a complete connector.

Because the upper and lower connector parts are made separately, the upper connector 40 can be made adaptable to different lower connector parts 48 and each of the lower connector parts 48 is made to have a fitting hole 49 for being inserted with stem 42.

Further, the lower connector 44 and the different lower connectors 48 can be connected to the upper connector part 40 or different upper connectors 46. Each of the upper connector parts 46 is provided for angular connection so that a transverse screw thread hole 47 communicates with a connecting hole 470 for connecting with pipeline of a cleaner in an angle instead of axial connection while no space is available for connecting with the pipeline axially.

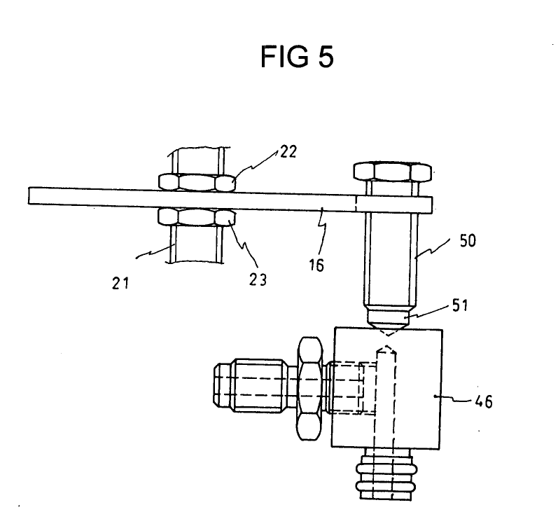

Referring to FIG. 5 in company with FIG. 4B, a further embodiment is illustrated. A locating hole 471 is provided at the upper connector section 46. Once the upper connector section 46 is assembled, a touch-push screw 50 passes through the elongated C shaped strap plate 16 with the front end thereof inserting into the locating hole 471. Thus, the upper connection part 47 and the lower connection part can be moved while the touch-push screw 50 is turned to regulate tightness of the connector joined to the connection part 24. In this way, the screw thread hole 47 is capable of connecting with various types of connecting elements. It is noted that the touch-push screw 50 is secured with the screw 21 and the nuts 22, 23 via the elongated C shaped strap plate 16.

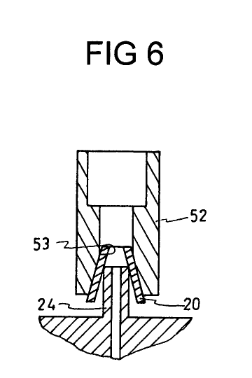

Referring to FIG. 6, a further embodiment is illustrated. Because the connection part 24 is provided with a variety of specifications, the lower connection part 52 is provided with a conical hole 53 to cover the connection part 24 and a sealing cone 20 is provided in the conical hole 53 in order to the connector 10 fitting with the connection part 24 tightly. Being similar to FIG. 1C, the sealing cone 20 allows the connection between the connector 10 and connection part 24 is completely tight without leakage like. In addition, the lower connection part 52 can be joined to the upper connection part 40 as the connector 10 instead of being separated from each other.

While the invention has been described with referencing to preferred embodiments thereof, it is to be understood that modifications or variations may be easily made without departing from the spirit of this invention, which is defined by the appended claims.

What is claimed is:

1. A universal connector, comprising:
a screw thread section with an end, connecting with an output pipe or a recycling pipe of a cleaning device of an air conditioning system; and
a conical section with another end, providing a plurality of flanges at the outer sides thereof and connecting with a connection member of the air conditioning system;
characterized in that the screw thread section connects with a C shaped strap plate, which has a C shaped groove is passed through a screw and the C shaped strap plate perpendicularly engaging with the screw by way of two nuts such that the connector is co-axial with a fitting hole in the connection member and move rectilinearly along a direction in parallel with the screw, which is fixed to the connection member.

2. The universal connector as defined in claim 1, wherein the screw is fixedly attached to a through hole of a locating plate such that the connector on the C shaped plate is co-axial with the fitting hole by means of the locating plate and a holding seat being fixedly mounted to the connection member plate and moves rectilinear in parallel with the screw.

3. The universal connector as defined in claim 2, wherein the screw is fixedly attached to a locator around the connection member by way of the locating plate such that the connector on the C shaped plate is co-axial with the fitting hole by means of the locating plate and a holding seat being fixedly mounted to the connection member plate and moves rectilinear in parallel with the screw.

4. The universal connector as defined in claim 1, wherein the connector is composed of an upper connection part and a lower connection part.

5. The universal connector as defined in claim 2, wherein the connector is composed of an upper connection part and a lower connection part.

6. The universal connector as defined in claim 1, wherein the connector is composed of an upper connection part and a lower connection part.

7. The universal connector as defined in claim 4, wherein the upper connection part has a stem attached with at least a sealing ring and the lower connection part has a joining hole.

8. The universal connector as defined in claim 5, wherein the upper connection part has a stem attached with at least a sealing ring and the lower connection part has a joining hole.

9. The universal connector as defined in claim 6, wherein the upper connection part has a stem attached with at least a sealing ring and the lower connection part has a joining hole.

10. The universal connector as defined in claim 4, wherein the upper connection section has a connecting hole communicates with a screw threaded hole therein and a locating is disposed at the outer side thereof for being inserted with a touch-push head of a touch-push screw.

11. The universal connector as defined in claim 5, wherein the upper connection section has a connecting hole communicates with a screw threaded hole therein and a locating is disposed at the outer side thereof for being inserted with a touch-push head of a touch-push screw.

12. The universal connector as defined in claim 6, wherein the upper connection section has a connecting hole communicates with a screw threaded hole therein and a locating is disposed at the outer side thereof for being inserted with a touch-push head of a touch-push screw.

13. The universal connector as defined in claim 1, wherein the connector has a conical hole fitting with an inner sealing cone.

14. The universal connector as defined in claim 2, wherein the connector has a conical hole fitting with an inner sealing cone.

15. The universal connector as defined in claim 3, wherein the connector has a conical hole fitting with an inner sealing cone.

16. The universal connector as defined in claim 4, wherein the connector has a conical hole fitting with an inner sealing cone.

17. The universal connector as defined in claim 5, wherein the connector has a conical hole fitting with an inner sealing cone.

18. The universal connector as defined in claim 6, wherein the connector has a conical hole fitting with an inner sealing cone.
